(19) United States
(12) Patent Application Publication
(10) Pub. No.: US 2024/0265210 A1
(43) Pub. Date: Aug. 8, 2024

(54) AUTOMATING GENERALIZATION OR PERSONALIZATION OF CONVERSATIONAL AUTOMATION AGENTS

(71) Applicant: INTERNATIONAL BUSINESS MACHINES CORPORATION, Armonk, NY (US)

(72) Inventors: Yara Rizk, Cambridge, MA (US); Ankita Bhaumik, Troy, NY (US); Vatche Isahagian, Belmont, MA (US); Vinod Muthusamy, Austin, TX (US); Praveen Venkateswaran, Cambridge, MA (US); Kartik Talamadupula, Snoqualmie, WA (US)

(21) Appl. No.: 18/163,771

(22) Filed: Feb. 2, 2023

(51) Int. Cl. G06F 40/35

(52) U.S. Cl. CPC G06F 40/35

(57) ABSTRACT

Automating generalization or personalization of conversational automation agents includes receiving, by computer hardware, a plurality of input conversations. The input conversations include, or are formed of, a plurality of utterances. A plurality of intents and slots are determined from the input conversations by processing the plurality of input conversations through a first classifier. A plurality of generalized intents are generated by performing entity recognition on the plurality of intents and slots using an entity recognizer. The entity recognizer is configured to apply a knowledge graph to the plurality of intents and slots. Slots of the plurality of input conversations as classified are masked to generate masked utterances. Conversational data, which includes the masked utterances and the plurality of generalized intents, are encoded as a plurality of feature vectors. A meta intent model is generated by processing the plurality of feature vectors through a second classifier using a conversation similarity metric.

### RESERVATION OF RIGHTS IN COPYRIGHTED MATERIAL

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

This disclosure relates to automation agents and, more particularly, to conversational automation agents.

A conversational automation agent, also referred to as a “task-oriented conversational assistant,” refers to an electronic system that is capable of performing tasks requested by users. Users request tasks to be performed by the conversational automation agent by way of natural language requests. The natural language requests may be received in the form of text or user spoken utterances that are converted to text. Conversational automation agents have gained widespread use across a variety of different industries. For example, conversational automation agents are capable of performing tasks including, but not limited to, making travel reservations, performing banking transactions, shopping online, or the like, on behalf of the user.

A conversational automation agent receives user-specified tasks by engaging in a conversation or dialog with the user. This dialog may involve multiple interactions or exchanges (e.g., referred to as “turns”) with the user. The conversational automation agent typically supports pre-defined sets of tasks that are executed based on user objectives, and their associated task parameters. In a conversational automation agent, objectives (e.g., actions) are called intents and the parameters for an intent (e.g., the “task parameters”) are referred to as slots. The intents and slots (e.g., values for the slots) are determined from the conversation carried out between the user and the conversational automation agent.

Often, users wish to perform complex tasks that do not map onto any single intent within the conversational automation agent. The user's complex task may, in fact, map onto, or involve, a plurality of different intents of the conversational automation agent. In this regard, the user-specified complex task is actually a multi-step process to be performed by the conversational automation agent. In the usual case, the user must request each individual step be performed by the conversation automation agent as a separate task. Thus, each smaller task of the complex task requires its own dialog with the user. In the usual case, conducting these dialogs for the various tasks of the larger, more complex task to be performed involves many redundant communications between the user and the conversational automation agent resulting in lengthy and cumbersome interactions with the user and the over-use of computational resources.

### SUMMARY

In one or more embodiments, a method includes receiving, by computer hardware, a plurality of input conversations. The input conversations include, or are formed of, a plurality of utterances. The method includes determining, by the computer hardware, a plurality of intents and slots from the plurality of input conversations by processing the plurality of input conversations through a first classifier. The method includes generating, by the computer hardware, a plurality of generalized intents by performing entity recognition on the plurality of intents and slots using an entity recognizer. The entity recognizer is configured to apply a knowledge graph to the plurality of intents and slots. The method includes masking slots of the plurality of input conversations as classified to generate masked utterances (e.g., a set of such utterances). The method includes encoding, by the computer hardware, conversational data as a plurality of feature vectors. The conversational data includes the masked utterances and the plurality of generalized intents. The method also includes generating, by the computer hardware, a meta intent model by processing the plurality of feature vectors corresponding to the plurality of input conversations through a second classifier using a conversation similarity metric.

In one or more embodiments, a system includes one or more processors configured to initiate executable operations. The executable operations include receiving a plurality of input conversations. The input conversations include, or are formed of, a plurality of utterances. The executable operations include determining a plurality of intents and slots from the plurality of input conversations by processing the plurality of input conversations through a first classifier. The executable operations include generating a plurality of generalized intents by performing entity recognition on the plurality of intents and slots using an entity recognizer. The entity recognizer is configured to apply a knowledge graph to the plurality of intents and slots. The executable operations include masking slots of the plurality of input conversations as classified to generate masked utterances (e.g., a set of such utterances). The executable operations include encoding conversational data as a plurality of feature vectors. The conversational data includes the masked utterances and the plurality of generalized intents. The executable operations also include generating a meta intent model by processing the plurality of feature vectors corresponding to the plurality of input conversations through a second classifier using a conversation similarity metric.

In one or more embodiments, a computer program product includes one or more computer readable storage mediums having program instructions embodied therewith. The program instructions are executable by one or more processors to cause the one or more processors to execute operations. The executable operations include receiving a plurality of input conversations. The input conversations include, or are formed of, a plurality of utterances. The executable operations include determining a plurality of intents and slots from the plurality of input conversations by processing the plurality of input conversations through a first classifier. The executable operations include generating a plurality of generalized intents by performing entity recognition on the plurality of intents and slots using an entity recognizer. The entity recognizer is configured to apply a knowledge graph to the plurality of intents and slots. The executable operations include masking slots of the plurality of input conversations as classified to generate masked utterances (e.g., a set of such utterances). The executable operations include encoding conversational data as a plurality of feature vectors. The conversational data includes the masked utterances and the plurality of generalized intents. The executable operations also include generating a meta intent model by processing the plurality of feature vectors corresponding to the plurality of input conversations through a second classifier using a conversation similarity metric.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing a meta intent generation (MIG) framework.

FIG. 2 illustrates an example architecture for the executable MIG framework of FIG. 1.

FIG. 3 illustrates an example method of operation of the MIG framework of FIGS. 1 and 2 in which a meta intent model is generated.

FIG. 4 illustrates an example representation of a complex task formed of a plurality of constituent intents.

FIG. 5 illustrates an example of a meta intent model as generated by the MIG framework of FIG. 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to automation agents and, more particularly, to conversational automation agents. In accordance with the inventive arrangements disclosed herein, methods, systems, and computer program products are provided that are capable of generating a meta intent model. The meta intent model may be used by a conversational automation agent to process utterances received from a user during a dialog or conversation with the user. The user utterances may specify a complex task (e.g., a meta intent) to be performed by the conversational automation agent. The complex task may include a plurality of constituent tasks (intents). That is, the task that the user requests the conversational automation agent to perform may be a complex task involving a plurality of other tasks.

In one or more example implementations, the meta intent model specifies a hierarchy of a plurality of related intents. The meta intent model further specifies relationships between the different slots of the related intents. For example, the meta intent model may specify or indicate relationships that allow the conversational automation agent to re-use slots across one or more intents specified in the meta intent model. This allows the meta intent model to be utilized so that fewer instructions (e.g., utterances) are needed from the user to specify the particular complex task, or meta intent, to be performed.

In one or more example implementations, in generating the meta intent model, a conversational similarity metric is used to compare different input conversations. Those conversations determined to be similar may be determined by the system as specifying like, similar, or same intents that may be generalized under a common parent node of the meta intent model that is automatically generated. For example, unlike other text-based similarity metrics that recognize certain conversations as dissimilar, the conversational similarity metric described herein recognizes such conversations as being related. Two seemingly different conversations such as one in which the user wishes to book a hotel and flight and another where the user wishes to travel by train and use a home sharing service would be recognized using the conversational similarity metric described herein as being related in that both pertain to booking a trip. By comparison, conventional text comparison techniques would recognize the two utterances to be dissimilar.

As an illustrative and non-limiting example, for a user to book a trip using a conventional system, the user may need to provide multiple different user utterances. For example, the user may provide utterances such as:
Can you look up flights for Boston to Florida for the 4^{th} of July weekend?
Can you reserve the cheapest one for 2 people?
Can you also look for hotels in Florida for the same dates and 2 people?
I think I need a rental car too in Florida? Do you have a list of available ones?

In this example, though the user is attempting to initiate the complex task of booking a trip, the user must specify each constituent task of that complex task individually by way of a separate utterance or separate series of utterances. The user must submit a request to book a flight, submit another request to book a hotel, and submit yet another request to rent a car. Further, though the data needed to book a flight, book a hotel room, and/or book a rental car may overlap or be shared among the various intents expressed by the user, the user must provide this information in a redundant manner through additional utterances or turns. That is, the user provides or otherwise specifies the dates, number of people, and locations for each individual task of the complex task multiple times. The conventional system is unable to determine that these tasks are linked or related.

In accordance with the inventive arrangements described herein, a conversational automation agent using a meta intent model allows a user to simply provide an utterance expressing a complex task such as “can you help me book a vacation to Florida for the 4^{th} of July weekend?” The conversational automation agent may understand that such a request specifies a meta intent that entails multiple constituent tasks (intents) such as booking transport, booking accommodations, and booking commute(s). For example, the conversational automation agent may respond to the user with “Sure! Booking a trip to Florida will include: booking flights/train, booking a hotel/short term stay, and getting a rental car. Let us get the bookings done.” Slots that are common to the constituent intents of the meta intent model may be re-used to fulfill the different intents.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

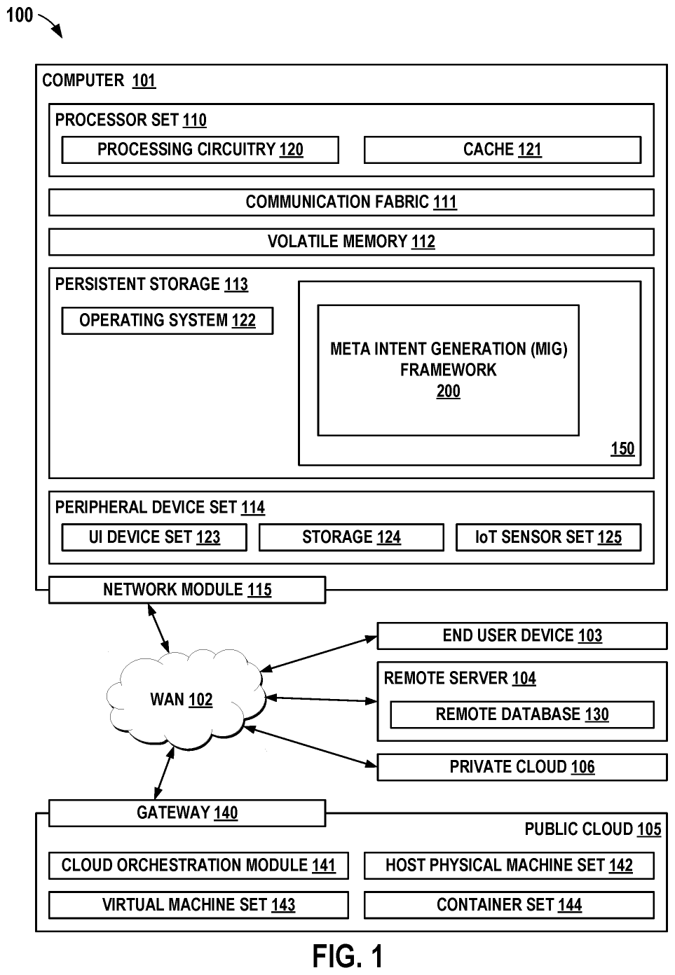

Referring to FIG. 1, computing environment 100 contains an example of an environment for the execution of at least some of the computer code in block 150 involved in performing the inventive methods, such as meta intent generation (MIG) framework 200. MIG framework 200 may be implemented as executable program code or instructions. In general, MIG framework 200 is capable of receiving a plurality of input conversations and, based on the input conversations, generating one or more meta intent models. Unlike other types of text input, the input conversations may be task-oriented conversations. Task-oriented conversations include distinct components such as intents, slots, and utterances that have an effect on the ability of a text and/or natural language processing system to determine similarity or overlap between different ones of the input conversations.

As an illustrative and non-limiting example, two input conversations obtained from two different users may have different objectives such as a booking travel and a product return. In other cases, different input conversations may include the same intents but provide different levels of slot information. In addition, task-oriented conversations typically include information that is provided over multiple conversation turns, where each turn may involve multiple user intents and slots. Further, the same set of tasks can be expressed using numerous possible user utterances depending on the users' choice of phrasing, order of sentences, use of colloquialisms, and/or the introduction of digression(s).

MIG framework 200 is capable of representing the structure of such task-oriented conversations as distributions over different task-oriented components and is capable of combining the geometry of the distributions with a conversation similarity metric derived from, and/or based on, optimal transport to measure the similarity between conversations. MIG framework 200 is capable of determining that conversations with similar intents, slot information, and analogous language reflect similar distributions, and hence have a lower cost of transportation (i.e., higher similarity). MIG framework 200 is capable of determining that differences in components of conversations result in a larger cost and, as such, a lower similarity.

By determining which of the received task-oriented conversations are similar, MIG 200 is capable of generating a meta intent model in which multiple different conversations may be generalized to the same meta intent. The meta intent model, as generated, specifies a hierarchy of related intents and corresponding slots. For example, the resulting meta intent model may be used by a conversational automation agent to process different task-oriented conversations. A first user may say “please help me look for flights from Boston to Florida on 1^{st} July.” A second user may say “I need to book trains between Boston and Albany.” While the two conversations specify different types of travel and different cities, both may be generalized to a meta intent such as “booking a trip.” In accordance with the inventive arrangements described herein, the resulting meta intent model, when used by a conversational automation agent, is capable of processing both requests as different instances or types of “booking a trip.” Use of the meta intent model allows the conversational automation agent to obtain information from the user to perform a meta intent such as “booking a trip” in less time (e.g., in fewer turns and with less duplication/redundancy in the conversation with the user) and using fewer computational resources of computer 101. Further details relating to operation of MIG framework 200 are described below.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and MIG framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

EUD 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

For purposes of discussion, each of computer 101, EUD 103, and public cloud 105 is an example of computer hardware that is capable of performing one or more or all of the various operations described within this disclosure.

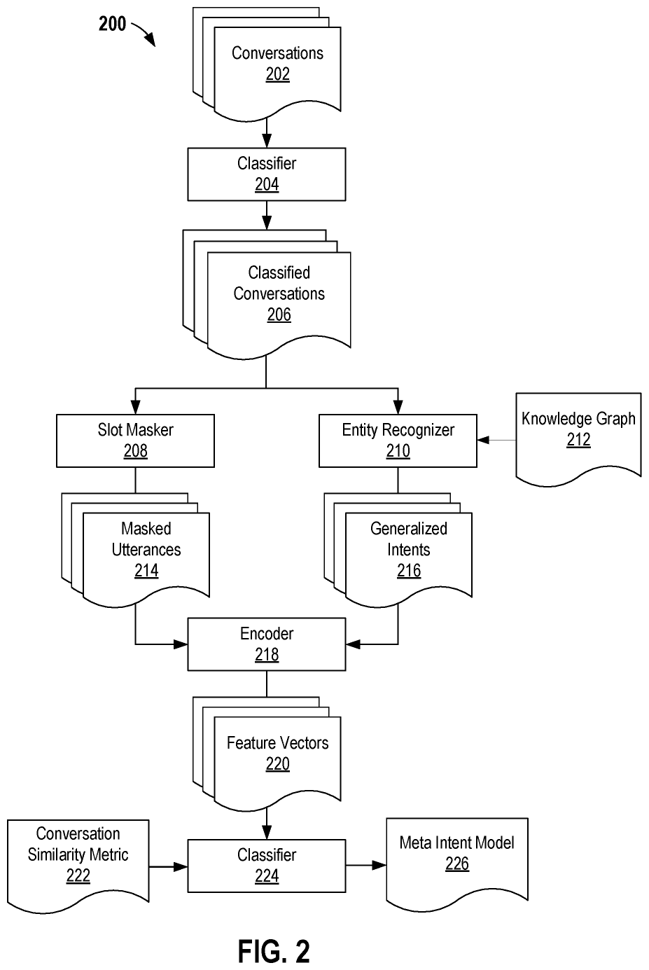

FIG. 2 illustrates an example architecture for executable MIG framework 200 of FIG. 1. In the example of FIG. 2, MIG framework 200 illustratively includes classifier 204, slot masker 208, entity recognizer 210, encoder 218, and classifier 224. FIG. 2 also illustrates conversations 202, classified conversations 206, masked utterances 214, generalized intents 216, feature vectors 220, conversation similarity metric 222, and meta intent model 226. The elements illustrated in FIG. 2 are examples of data structures that may be created, stored, accessed, executed, or otherwise utilized in performing the operations described herein.

As defined within this disclosure, the term “data structure” means a physical implementation of a data model's organization of data within a physical memory. As such, a data structure is formed of specific electrical or magnetic structural elements in a memory. A data structure imposes physical organization on the data stored in the memory as used by an application program executed using a hardware processor.

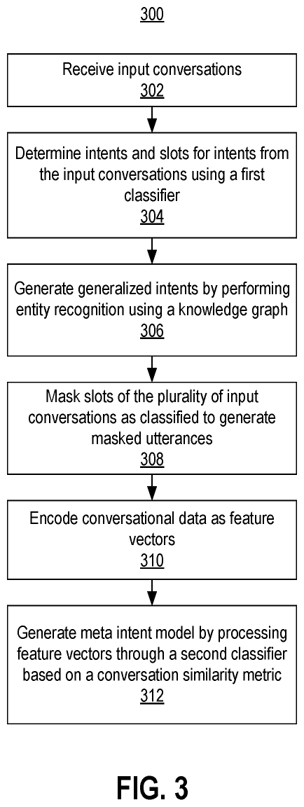

FIG. 3 illustrates an example method 300 of operation of the MIG framework 200 of FIGS. 1 and 2 in which a meta intent model 226 is generated.

Referring to FIGS. 2 and 3 collectively, in block 302, MIG framework 200 receives input conversations 202. In the example, classifier 204, which may be implemented as an intent classifier, receives conversations 202. Conversations 202 may be task-oriented conversations as previously described that have been collected from one or more different users. Each conversation may include one or more user utterances. Within this disclosure, an utterance refers to a natural language response from a user specified as text. The user utterance may be typed directly by a user or may be derived from another modality of communication such as user speech (e.g., user spoken utterances, sign language, or the like). For example, conversations 202 may be a plurality of task-oriented conversations conducted between one or more different users and one or more conversational automation agents or other conversational systems. Conversations 202 may be dialogs in which a user is instructing or asking a conversational automation agent to perform a task such as book a flight, book a hotel, rent a car, apply for a loan, or the like.

In block 304, MIG framework 200 determines intents and slots for the intents from the input conversations using classifier 204. In the example, classifier 204 is an intent classifier that is trained or otherwise capable of processing conversations 202 to identify intent(s) therein. Classifier 204 is also capable of identifying slots of the identified intent(s). In the example, classifier 204 is capable of embedding the intent data, e.g., the identified intent(s) and corresponding slot(s), within conversations 202 and outputting the result as classified conversations 206. In the example, classified conversations 206 include conversations 202 with the intent data (e.g., intents and slots as identified by classifier 204) embedded therein.

In the example of FIG. 2, classified conversations 206 may be processed through two distinct paths. The first path includes slot masker 208. The second path includes entity recognizer 210. In one aspect, the two paths, e.g., slot masker 208 and entity recognizer 210, are capable of operating in parallel. In another aspect, the two paths may operate in serial fashion albeit on the particular data items described herein and still generating the respective outputs illustrated.

In block 306, MIG framework 200 generates generalized intents 216 by performing entity recognition. More particularly, entity recognizer 210 is capable of processing classified conversations 206 using knowledge graph 212 to generate generalized intents 216. Knowledge graph 212, which may be referred to as a “semantic network,” may be implemented as a data structure that represents or specifies a network of real-world entities. Examples of the real-world entities that may be specified by a knowledge graph include objects, events, situations, or concepts. Knowledge graph 212 illustrates the relationship between these real-world entities. In some aspects, knowledge graph 212 may be specified as a graph database. For example, in some examples, knowledge graph 212 may be visualized as a graph structure. Knowledge graph 212 may be specified as a domain-specific knowledge graph, as a “common-sense” knowledge graph, or other type of knowledge graph.

In one or more example implementations, entity recognizer 210 is capable of comparing or correlating classified conversations 206 with knowledge graph 212 to detect objects from knowledge graph 212 within classified conversations 206. For example, entity recognizer 210 is capable of detecting objects specified by knowledge graph 212 within the intents and/or slots of classified conversations 206. Entity recognizer 210 is capable of embedding the recognized objects within classified conversations 206 as semantic information. Entity recognizer 210 is also capable of determining additional semantic information from knowledge graph 212 such as hierarchical relationships between objects detected within classified conversations 206, as specified by knowledge graph 212, and embed such additional hierarchical information within classified conversations 206 as further semantic data information resulting in generalized intents 216.

In block 308, MIG framework 200 generates masked utterances 214 from classified conversations 206. In the example, slot masker 208 is capable of masking slots within classified conversations 206 to generate masked utterances 214. Masked utterances 214 include versions of the utterances from conversations 202 in which words determined to be slots, based on classifier 204, are masked out. The words determined to be slots may be replaced with another word marker or indicator of a slot type or category as opposed to the more detailed value in the original utterance. For example, slots detected within classified conversations 206 may be masked by replacing the word determined to be a slot with a name from an ontology. The ontology may be a knowledge graph, whether private, proprietary, open source, or publicly available ontology such as is available from ConceptNet. In one example implementation, slot masker 208 may access knowledge graph 212. In any case, the ontology defines certain relationships such as “New York->City” for appropriate slot references for specific words.

For example, a first utterance may state “book a trip from New York to Miami.” A second utterance may state “book a trip from Boston to San Francisco.” In these examples, the cities are slots, or values for slots, for the intent “book a trip.” Slot masker 208 is capable of masking the slots by replacing the actual city names with labels such as “depart_city” or “arrival_city.” Post masking, the two utterances state each state “book a trip from DEPART_CITY to ARRIVAL_CITY.” It can be determined that each masked slot corresponds to a same category which is a city in this example. The masking operation ensures that entities representing slot values do not incorrectly bias or ambiguate the similarity of the embeddings. This prevents the conversation similarity metric that will be computed by way of comparing text including the two utterances from indicating a difference, or too much of a difference, due to the different slot values.

In block 310, MIG framework 200 encodes conversational data as feature vectors 220. More particularly, encoder 218 is capable of encoding the conversational data into feature vectors 220. In this example, the conversational data includes masked utterances 214 and generalized intents 216. The conversational data includes different types of information including, but not limited to, slot descriptions (e.g., the masked slots of masked utterances 214) and the semantic information included in generalized intents 216 (e.g., recognized entities and entity relationship data embedded in the generalized intents). In one aspect, encoder 218 may be implemented as a deep-learning model. For example, encoder 218 may be implemented as a transformer or attention-based machine learning model.

In block 312, MIG framework 200 generates meta intent model 226 by processing feature vectors 220 through classifier 224 (e.g., a second and different classifier) based on conversation similarity metric 222. More particularly, classifier 224 receives feature vectors 220 as input and processes the feature vectors 220 based on conversation similarity metric 222 to generate meta intent model 226. In processing feature vectors 220, classifier 224 classifies a node, as represented by a feature vector, as a child of an existing node or inserts a new node into a node hierarchy (to become meta intent model 226) based on conversation similarity metric 222. In this example, the term “node” refers to an intent. As created, the meta intent model 226 forms a hierarchy or tree of intents. In general, the user utterances are converted to feature vectors as conversation similarity metric 222 operates on feature vectors. The user utterances are associated with the intents (e.g., nodes of meta intent model 226). The feature vectors are used by classifier 224 to determine the hierarchy of the intents (e.g., nodes) of meta intent model 226.

In general, in generating meta intent model 226, classifier 224 is capable of determining whether the similarity between two nodes is less than a predetermined threshold based on conversation similarity metric 222. In response to determining that two nodes are similar, e.g., where the delta between the conversation similarity metric 222 of each node does not exceed the predetermined threshold, classifier 224 considers the nodes to be the same. In this case, the two nodes may be represented by a single node of the meta intent model 226. In response to determining that the two nodes are dissimilar, e.g., the delta between the conversation similarity metric of each node exceeds the predetermined threshold, classifier 224 considers the nodes to be different. In that case, classifier 224 is capable of creating a new intent category and adding a node representing that new intent category to the meta intent model 226 and adding one or more types of entities recognized by the entity recognizer to the new intent category or node of the meta intent model 226.

Classifier 224 is capable of using information from knowledge graph 212 and using conversation similarity metric 222 to generalize intents into higher level intents. As an illustrative and non-limiting example, in recognizing that two intents are effectively the same or similar based on conversation similarity metric 222, classifier 224 may create a higher-level node as a new category, e.g., a parent node, under which both similar nodes may be placed as child nodes indicating their relationship to one another as siblings and to the higher-level node as a parent.

In one aspect, in applying conversation similarity metric 222, classifier 224 generates distributions of intents, slots and words across two conversations being compared. Classifier 224 is capable of calculating the optimal transport distance between the two conversations using pairwise distances as a cost matrix. In this regard, classifier 224 is capable of calculating a weighted metric based on the optimal transport distance between conversations. The weighted cost metric is calculated using information such as intent distribution across the conversation and intent embeddings, slots and embeddings of slot descriptions, and/or word distribution and sentence embeddings.

The following discussion provides additional detail regarding conversation similarity metric 222 and the application of the metric by classifier 224. For purposes of illustration, the simplex of utterance embeddings of a conversation (e.g., of conversations 202) may be denoted as Δ_{U}^{l}. Classifier 224 is capable of computing probability simplexes Δ_{I}ⁿ, Δ_{S}^{m} for each conversation over the set of intents I and slots S such that Δ_{K}ⁿ={pᵢ∈ [symbol] ⁿ⁺¹|Σᵢ₌₀ⁿpᵢ=1, pᵢ≥0∀i∈|K|}, where each pᵢ reflects the frequency of occurrence of intents and slots over the utterances. For example, Δ_{I}ⁿ for conversation Cᵢ represents the probability of all n intents within Cᵢ. Classifier 224 also computes a cost matrix M_{i,j} for each component that represents the cost to move between two points (i,j) in its distribution. Classifier 224 further computes each entry using the Euclidean distance between the embeddings generated for each component.

For example, given simplexes α∈Δ_{K}ⁿ, β∈Δ_{K}^{m} and the cost matrix M, the 1-Wasserstein distance between the two simplexes is

$${W}_{1} ( p , q ) = {min}_{Γ ∈ {ℝ}^{n x m}} {\sum }_{i , j} {M}_{i , j} {Γ}_{i , j}$$

subject to Σⱼ┌_{i,j}=αᵢ and Σⱼ┌_{i,j}=βⱼ, where M_{i,j}=d(i,j) denotes the cost matrix and d denotes the distance between the distributions. The conversational similarity metric 222 between two task-oriented conversations C₁ and C₂ is defined as the weighted sum of the W₁ distances between their respective components as set forth in expression 1 below.

$$ConversationalSimilarityMetric ( {C}_{1} , {C}_{2} ) = \sum γ {W}_{1} ( {C}_{1}^{⊕} , {C}_{2}^{⊕} ) \qquad ( 1 )$$

Referring to expression 1, C₁^{⊕}={Uᵢ,Iᵢ,Sᵢ} represents the conversation's components (i.e., utterances, intents, and slots) and γ is a hyperparameter reflecting the influence of each component on the similarity.

The inventive arrangements described herein, in generating meta intent model 226 by virtue of conversational similarity metric 222, account for characteristics such as intents and slots that are specific to task-based conversations. Other text similarity determination techniques do not account for characteristics specific to task-based conversations and, in consequence, and are less accurate in terms of their ability to generate similarity metrics for task-based conversations compared to the inventive arrangements described herein.

For example, some similarity metrics are specialized for conversations and other similarity metrics are not specialized for conversations. Of those that are specialized for conversations, such techniques do not utilize optimal transport distance. Using optimal transport distance, however, without the adaptations described herein, e.g., where the feature vectors incorporate the different components described such as, e.g., intents, slots, and semantic information for the utterances, does not provide the level of performance obtained using conversation similarity metric 222 as formulated and described herein. As such, the conversation similarity metric 222 as described herein is capable of outperforming other similarity metrics that are conversation specific and do not utilize optimal transport distance and also those that do use optimal transport distance but are adapted to contexts other than conversations. As discussed, the conversation similarity metric 222 leverages intent distributions, embedded information in the intents and/or slots, and word distributions (e.g., semantic information). In this example, the word distribution refers to the embedding vectors (e.g., embedded information) associated with all the words within the user utterances. The embedding vectors represent the semantic information and/or similarity between words that is leveraged by the conversation similarity metric 222.

In the example, the various input conversations 202 are used to teach MIG framework 200 different complex tasks by evaluating the complex tasks using the illustrated processing architecture including conversation similarity metric 222. In general, MIG framework 200, in applying the operations described with reference to FIGS. 2 and 3, detects similarity between intents from different, but similar conversations, and groups the intents to have the same parent nodes or inserts the intents as leaf nodes in the hierarchy being created as meta intent model 226. This process facilitates context sharing among the intents.

In one or more example implementations, meta intent model 226 may be specified as a hierarchy of a plurality of intents and corresponding slots. In one aspect, meta intent model 226 specifies relationships between the respective intents (e.g., corresponding to the plurality of input conversations) and also relationships between the plurality of intents and the plurality of slots. In one aspect, the plurality of slots that are included or specified by meta intent model 226 are a union of slots for the plurality of intents.

While meta intent model 226 specifies generalizations for intents, in another aspect, meta intent model 226 is also capable of specifying personal preferences for particular users (e.g., user-specific preferences). For example, higher-level nodes may represent general intents that are common across a plurality of different users. Lower-level nodes, e.g., leaf nodes, of meta intent model 226 may specify user-specific preferences of particular users.

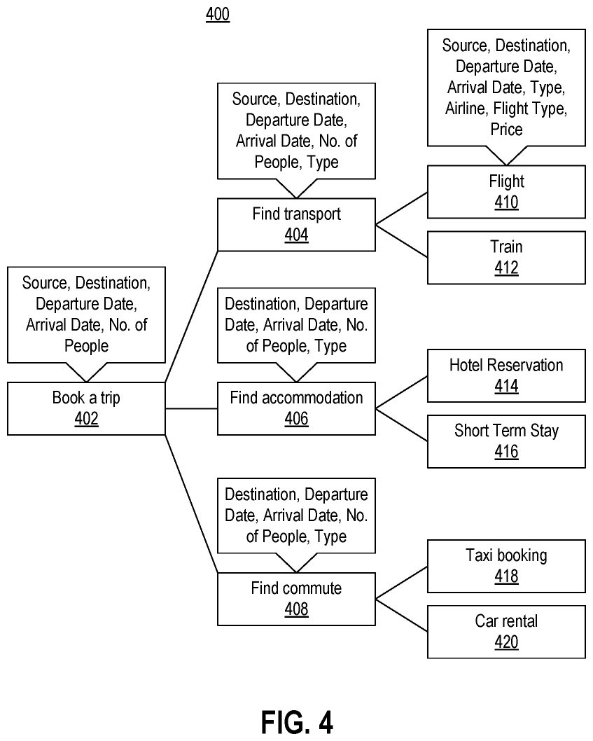

FIG. 4 illustrates an example representation of a complex task 400 broken out into a plurality of constituent intents. In the example of FIG. 4, complex task 400 includes intents 402 “book a trip,” 404 “find transport,” 406 “find accommodation,” 408 “find commute,” 410 “flight,” 412 “train,” 414 “hotel reservation,” 416 “short term stay,” 418 “taxi booking,” and 420 “car rental.” The particular slots corresponding to each of the respective intents are illustrated as text within text bubbles above the respective intents. For example, as illustrated, the slots for intent 402 “book a trip” are source, destination, departure date, arrival date, and number of people. Intent 402 encompasses other intents 404, 406, and 408 which can be modeled as children to intent 402. A review of the slots for the different intents reveals a significant amount of overlap between intents. That is, some intents share one or more slots with other intents. The “type” indicator within the set of slots indicates that the intent has child nodes. For example, the intent 404 “find transport” has a type indicator since the mode of transport may be flight or train. The intent 410 “flight” has a type indicator since there may be a variety of different possible types of flights (not shown) such as direct or direct.

The meta intent model 226, which is automatically generated by MIG framework 200, specifies the various intents needed to perform a complex task or meta intent. Meta intent model 226 is capable of capturing the relationships of constituent intents and slots of complex task 400. Further, whereas a conventional system may repetitively ask the user for certain information that is relevant to multiple different intents of the complex intent, meta intent model 226 specifies which slots are common to the different intents and may be re-used across the different intents of the intent hierarchy specified by meta intent model 226.

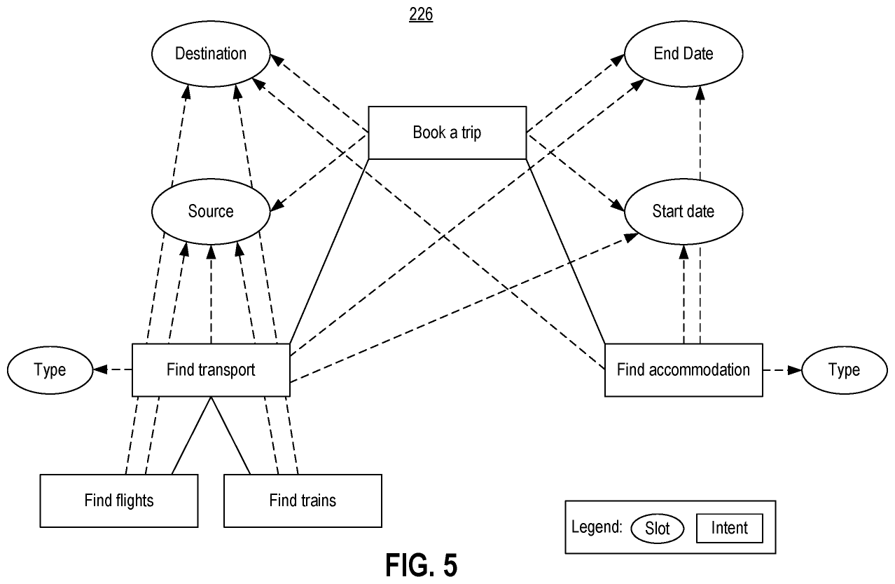

FIG. 5 illustrates an example of meta intent model 226. The example of FIG. 5 is a visual representation of meta intent model 226. It should be appreciated that meta intent model 226 may be specified using any of a variety of different programming languages and/or syntaxes that are computer readable.

The example of FIG. 5 illustrates how meta intent model 226 specifies a hierarchical organization of intents. In the example, the intents include “book a trip,” “find transport,” “find flights,” “find trains,” and “find accommodation.” The example of FIG. 5 is a simplified in that certain ones of the intents illustrated may include additional child intents that are not shown. The “find accommodation” intent, for example, may include additional child intents relating to hotel stay or home stays (e.g., home sharing/renting services).

In the example, the “find transport” intent includes two child intents that reflect the “type” indicator of FIG. 4. In this example, the type indicator may signify the availability of two or more Application Programming Interfaces (APIs) to the conversational automation agent, where each API is represented as a different intent. The two APIs in this example may be a flight reservation API and a train reservation API. Each of the APIs may require certain data as input such as a source and destination shown as slots of the respective intents.

In the example, the hierarchy of intents are illustrated with solid lines linking the intents to form parent-child relationships. The relationships between intents and slots are illustrated with dashed lines. For example, meta intent model 226 of FIG. 5 illustrates that the destination slot is shared, or used, by the following intents: “find flights,” “find trains,” “book a trip,” and “find accommodation.” The source slot is shared, or used, by the following intents: “find transport,” “find trains,” “book a trip,” and “find accommodation.” Other slots are shared between other intents.

The hierarchy of FIG. 5 shows how a conversational automation agent may use meta intent model 226 in real time to process user conversations. The conversational automation agent, for example, is capable of traversing meta intent model 226 while processing received user utterances to determine the particular complex task being requested and the information that is needed. In traversing meta intent model 226, the conversational automation agent may move from leaves (e.g., specific) to the root (e.g., general) or vice versa depending on the particular user utterances received and the ordering of such user utterance.

For example, in response to the user initially providing utterances determined to correspond to “find transport,” the conversational automation agent may traverse meta intent model 226 toward the leaves to determine the type of transport and then traverse toward the root to generalize and then back toward the leaves to determine that accommodations are needed. Alternatively, in response to the user providing an utterance corresponding to finding an accommodation, the conversational automation agent may determine the type of accommodation desired and then traverse up to “book a trip” and down to “find transport” based on the defined relationships between intents. Data obtained for the various slots may stored and re-used for the different intents that share, or use, the respective slots. That is, based on meta intent model 226, the conversational automation agent is capable of determining that the start date and end date specify the length of stay for the accommodation and specify the departure data and the return date for the transport. Such data is re-used for both intents. In any case, having received and identified certain data such as slots, the slots may be re-used across the different intents of meta intent model 226 as opposed to asking for the same data from the user at least one time for each intent that requires the data.

In one or more other example implementations, historical data from different users may be stored in a database or other data structure in a data storage device and made available to the conversational automation agent to process subsequent user utterances and/or conversations from the user. From the historical data, for example, user preferences may be determined and stored. An example of a user preference is that User A prefers air travel while User B prefers train travel. User A may prefer hotel stays whereas User B prefers home sharing services. User A may prefer using taxis as the commute (e.g., mode of travel at the destination) while User B prefers ride sharing services. In another example, a user may reside in a location where only one mode of transport is available thereby precluding other modes of transport. In any case, such preferences may be stored on a per-user or user-specific basis.

Accordingly, in processing subsequent conversations from a user for whom preferences are stored, the preferences may be used automatically by the conversational automation agent to avoid querying the user for such information. In that case, the pre-stored preferences for particular intents may be pre-populated. In some example implementations, those intents for which user preferences are preserved may be tagged or otherwise annotated in meta intent model 226. In that case, upon encountering an intent in meta intent model 226 so tagged or annotated, the conversational automation agent may query the data store of user preferences for a pre-determined preference that may be used to automatically populate the intent of meta intent model 226 being traversed.

By utilizing meta intent model 226, a conversational automation agent is able to improve natural language understanding for what would otherwise be considered “out-of-scope” intents and utterances. An out-of-scope event may include a fallback, which is a low confidence event. A fallback is not necessarily an error. In some cases, the fallback event may occur in situations where the conversational automation agent lacks prior information about the intent/utterances.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, by computer hardware, a plurality of input conversations comprised of a plurality of utterances;
determining, by the computer hardware, a plurality of intents and slots from the plurality of input conversations by processing the plurality of input conversations through a first classifier;
generating, by the computer hardware, a plurality of generalized intents by performing entity recognition on the plurality of intents and slots using an entity recognizer configured to apply a knowledge graph to the plurality of intents and slots;
masking, by the computer hardware, slots of the plurality of input conversations as classified to generate masked utterances;
encoding, by the computer hardware, conversational data as a plurality of feature vectors, wherein the conversational data includes the masked utterances and the plurality of generalized intents; and
generating, by the computer hardware, a meta intent model by processing the plurality of feature vectors corresponding to the plurality of input conversations through a second classifier using a conversation similarity metric.

2. The method of claim 1, wherein the masked utterances are generated by masking slots determined in the plurality of utterances.

3. The method of claim 1, wherein the meta intent model specifies relationships between a plurality of intents corresponding to the plurality of input conversations and relationships between the plurality of intents and a union of slots for the plurality of intents.

4. The method of claim 1, wherein the conversation similarity metric includes an optimal transport distance.

5. The method of claim 4, wherein the conversational data encoded as the plurality of feature vectors further comprises slot descriptions added via the masking and semantic information added by the entity recognition for the plurality of utterances.

6. The method of claim 1, wherein the generating the plurality of generalized intents comprises creating a new intent category and adding one or more types of entities recognized by the entity recognizer to the new intent category.

7. The method of claim 1, further comprising:
determining a plurality of related tasks from a subsequent input conversation by processing the subsequent input conversation through a conversational automation agent applying the meta intent model.

8. The method of claim 1, wherein the second classifier performs pairwise comparisons of the plurality of feature vectors across the plurality of input conversations and groups two or more intents into the meta intent model based on the pairwise comparisons.

9. A system, comprising:
one or more processors configured to execute operations including:
receiving a plurality of input conversations comprised of a plurality of utterances;
determining a plurality of intents and slots from the plurality of input conversations by processing the plurality of input conversations through a first classifier;
generating a plurality of generalized intents by performing entity recognition on the plurality of intents and slots using an entity recognizer configured to apply a knowledge graph to the plurality of intents and slots;
masking slots of the plurality of input conversations as classified to generate masked utterances;
encoding conversational data as a plurality of feature vectors, wherein the conversational data includes the masked utterances and the plurality of generalized intents; and
generating a meta intent model by processing the plurality of feature vectors corresponding to the plurality of input conversations through a second classifier using a conversation similarity metric.

10. The system of claim 9, wherein the masked utterances are generated by masking slots determined in the plurality of utterances.

11. The system of claim 9, wherein the meta intent model specifies relationships between a plurality of intents corresponding to the plurality of input conversations and relationships between the plurality of intents and a union of slots for the plurality of intents.

12. The system of claim 9, wherein the conversation similarity metric includes an optimal transport distance.

13. The system of claim 12, wherein the conversational data encoded as the plurality of feature vectors further comprises slot descriptions added via the masking and semantic information added by the entity recognition for the plurality of utterances.

14. The system of claim 9, wherein the generating the plurality of generalized intents comprises creating a new intent category and adding one or more types of entities recognized by the entity recognizer to the new intent category.

15. The system of claim 9, wherein the one or more processors are configured to execute operations further comprising:
determining a plurality of related tasks from a subsequent input conversation by processing the subsequent input conversation through a conversational automation agent applying the meta intent model.

16. The system of claim 9, wherein the second classifier performs pairwise comparisons of the plurality of feature vectors across the plurality of input conversations and groups two or more intents into the meta intent model based on the pairwise comparisons.

17. A computer program product comprising one or more computer readable storage mediums having program instructions embodied therewith, wherein the program instructions are executable by one or more processors to cause the one or more processors to execute operations comprising:
receiving a plurality of input conversations comprised of a plurality of utterances;
determining a plurality of intents and slots from the plurality of input conversations by processing the plurality of input conversations through a first classifier;
generating a plurality of generalized intents by performing entity recognition on the plurality of intents and slots using an entity recognizer configured to apply a knowledge graph to the plurality of intents and slots;
masking slots of the plurality of input conversations as classified to generate masked utterances;
encoding conversational data as a plurality of feature vectors, wherein the conversational data includes the masked utterances and the plurality of generalized intents; and
generating a meta intent model by processing the plurality of feature vectors corresponding to the plurality of input conversations through a second classifier using a conversation similarity metric.

18. The computer program product of claim 17, wherein the meta intent model specifies relationships between a plurality of intents corresponding to the plurality of input conversations and relationships between the plurality of intents and a union of slots for the plurality of intents.

19. The computer program product of claim 17, wherein the conversation similarity metric includes an optimal transport distance.

20. The computer program product of claim 19, wherein the conversational data encoded as the plurality of feature vectors further comprises slot descriptions added via the masking and semantic information added by the entity recognition for the plurality of utterances.
